(19) United States
(12) Patent Application Publication
(10) Pub. No.: US 2003/0173772 A1
(43) Pub. Date: Sep. 18, 2003

(54) Advertisement print optimised for at least two viewpoints

(76) Inventors: Erik B. Thomsen, Vejle (DK); Christian Sondergaard, Vandel (DK)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/095,463

(22) Filed: Mar. 13, 2002

(51) Int. Cl. G09F 1/00

(52) U.S. Cl. 283/56

(57) ABSTRACT

This invention relates to an advertisement print being printed on a substantially plane print carrier. The print is a transformation of a chosen three-dimensional geometrical element having a number of visible sides defined by at least a first viewpoint and a second viewpoint. The sides are combined and the print can optimally be viewed from two different viewpoints, even though they are pointing in opposite directions. The invention is e.g. especially advantageous in cricket games and the like, where the game is typically broadcasted using two or more main cameras pointing in substantially opposite directions.

### FIELD OF THE INVENTION

The invention relates to an advertisement print being printed on a substantially plane print carrier.

### BACKGROUND OF THE INVENTION

The use of advertising panels fixed in areas where a large number of people gather is a classic method of static advertising, which allows for example the transmission of images to the viewers resulting in a consequent advertising effect.

It is customary to use the system of fixed advertising panels combined with television projector cameras and the like at sports grounds, for example football grounds or other places where the high concentration of spectators justifies the application of this system of advertising.

However, the arrangement of fixed advertising panels has a drawback with regard to its visualization from television cameras, which are situated in fixed and predetermined locations at the sports ground or other similar place. The drawback consists fundamentally in that the angle of the optical axis of the lens of the camera with respect to the plane of the fixed panel is variable according to the position of the said panel at the ground. Thus, for example, if the television camera is installed at one side, the angle at which an advertising panel arranged exactly on the opposite side of the ground, or a fixed advertising panel arranged for example behind a goal, is seen, is very different, since the image captured by the optical system, which is that transmitted by the television system, may vary considerably from cases in which the view is practically perfect to cases in which, given the very unfavourable angle between the optical axis of the lens of the camera and the advertising panel, the image captured by the camera may end up by being practically unrecognisable, thus reducing to a great extent the desired advertising effect.

It is also known to apply a figurative print, like an advertising print, on a plane print carrier, such as a football field. The print is depicted in two dimensions, like the print will normally appear on a plane print carrier. Thus, the print should be viewed perpendicularly to the plane print carrier and, especially in connection with football fields this is an advantage so that many of the spectators at the football match may see the advertising print. However, it is a drawback that a spectator like a television viewer of a television transmitted football match does not get the full benefit from the advertising value of the advertising print, as a given TV camera is not necessarily placed and views the advertising print in such a way that the advertising print appears in the best possible way for a television viewer.

WO 93/04559 describes an image, e.g. of an advertising or promotional nature, which is depicted by inverse perspective transformation on a playing field for a sporting event. The playing field is imaged by means of a video camera whose line of sight corresponds to the line of sight used in transforming the image to its inverse perspective form, and the output of the camera is then broadcasted or diffused in a television broadcasting or diffusion service. Thereby, because of perspective transformation, the viewer viewing the broadcasted image intercepts a perspective transformation of the image. A problem with this is that in order for the viewer to see the correct perspective transformation of the image, it is necessary to use the video camera whose line of sight corresponds to the line of sight used in transforming the image to its inverse perspective form. If a second camera is introduced, then it might be impossible to get the advert message from the image when viewing the image via this second camera. Especially when the second camera is placed at the opposite end of the playing field, it is impossible to interpret the image and thereby the advertising information in the image.

### OBJECT AND SUMMARY OF THE INVENTION

It is an object of the invention to provide an advertisement print solving the above-mentioned problem.

This is obtained by providing an advertisement print being printed on a substantially plane print carrier, said print being a transformation of a three-dimensional element having a number of visible sides defined by at least a first viewpoint and a second viewpoint, where said print comprises a first part being a perspective projection of a first of said predefined visible sides to said print carrier according to a first line of sight defined by said first viewpoint and a second part being a perspective projection of a second of said visible sides to said print carrier according to said second line of sight defined by said second viewpoint. Thereby, the print can be viewed from at least two viewpoints. When the plane print is viewed from these viewpoints, a perspective transformation takes place and the viewer interprets the image print as one three-dimensional element. One part is then optimally viewed from the first viewpoint and interpreted as a side in a three-dimensional element, and a second part is optimally viewed from the second viewpoint and interpreted as a second side in a three-dimensional element. When viewed from e.g. the first viewpoint, the part optimised for the second viewpoint is interpreted as another side in a three-dimensional object.

The viewer could be a spectator in e.g. a sport event placed at specific viewpoints or a video camera placed at specific viewpoints transmitting the sport event to a number of viewers. The image could also be placed on the side of a road, whereby a viewer passing the image in either direction would interpret the image as a three-dimensional element.

In a specific embodiment the advertisement print further comprises a third part illustrating a perspective projection of a third of said visible sides to said print carrier according to a combination of a third line of sight at least defined by said first viewpoint and a point on said second part and a fourth line of sight at least defined by said second viewpoint and a point on said first part. Thereby, advertisement prints having more than two visible sides can be easily projected.

In another specific embodiment the third part is bounded by said first and second part and a first line being parallel to a third line of sight defined by said first viewpoint and a point being common for said second part and said third part having the longest distance to said first viewpoint, and a second line being parallel to a fourth line of sight defined by said second viewpoint and a point being common for said first part and said third part having the longest distance to said second viewpoint. Thereby, the print can be generated in a simple way, which is especially advantageous for generating the third part of advertisement prints illustrating box shaped elements.

In an embodiment at least the first and second side on said three-dimensional element comprises commercial information. Because of the three-dimensional effects it is easier to get the attention of the viewer, than if it was an ordinary 2-dimensional advertising print. Thereby a much more powerful commercial effect is obtained. The commercial information could e.g. be a logo.

In another embodiment at least a fourth part is placed on said third part, said fourth part being a perspective projection of an object to said print carrier according to a fifth line of sight defined by a third viewpoint. Thereby the image can provide information to a viewer placed at the third viewpoint even though the image cannot be optimally interpreted as a three-dimensional element from the third viewpoint.

In a specific embodiment said three-dimensional element is a box and said first visible side is a first surface on said box, said second visible side is a second surface on said box and said third visible side is a third surface on said box being visible from both said first viewpoint and said second viewpoint.

In another embodiment said three-dimensional element is a cylinder and said first visible side is a first surface on said cylinder, said second visible side is a second surface on said cylinder and said third visible side is a third surface on said cylinder being visible from both said first viewpoint and said second viewpoint.

Thereby the image can be interpreted as a known object having the form of either a cylinder or a box. Examples of known cylindrical elements are food cans and beverage cans, and examples of known box shaped elements are a chocolate bar, chewing gum, packaging for medical products and mobile phones.

In an embodiment said first line of sight is pointing in a direction substantially towards said second viewpoint and said second line of sight is pointing in a direction substantially towards said first viewpoint. This is an advantageous embodiment, because in this case the first part makes no sense to the viewer and therefore it is especially important to introduce the second and third part resulting in the first part being interpreted as a side on a three-dimensional element.

In a specific embodiment the print carrier is a removable mat. The mat could e.g. be artificial grass or foil. Thereby the image can easily be removed and e.g. replaced by a mat representing another image. Further, the image can then be produced at a first production place and then placed at e.g. the playing field and a side of the road afterwards.

In another embodiment the print carrier is a ground surface. The ground surface could e.g. be a lawn, a slope along a road, a yard, a parking lot, a football field, a racing field or floors in e.g. the lounge of an airport, shopping malls and exhibition centres.

In a specific embodiment the ground surface is the ground surface of a cricket field. In this case it is especially interesting to have a print that has advertisement, which can be intercepted from two view angles since cricket games are broadcasted using two or more main cameras pointing in substantially opposite directions but at the given print carrier.

In another specific embodiment the advertisement print is provided by a projector pointing towards a substantially plane surface. Thereby the image can easily be applied and changed. The image could e.g. be changed continuously whereby the image can present a three-dimensional animation optimised for at least two optimal viewpoints.

### BRIEF DESCRIPTION OF THE DRAWINGS

In the following preferred embodiments of the invention will be described referring to the figures, wherein

FIG. 1 is a print carrier illustrating a three-dimensional box shaped element optimised for two viewpoints,

FIG. 2 illustrates the print carrier shown in FIG. 1 as it is interpreted from the first viewpoint,

FIG. 3 illustrates the print carrier shown in FIG. 1 as it is intercepted from the second viewpoint,

FIG. 4 shows two print carriers each illustrating a three-dimensional cylinder shaped element—one optimised for two viewpoints and the other optimised for three viewpoints,

FIG. 5 illustrates the print carrier shown in FIG. 4, as it is interpreted from an optimal viewpoint,

FIG. 6 shows a print carrier illustrating a three-dimensional pyramid shaped element optimised for two viewpoints,

FIG. 7 is a print carrier illustrating a three-dimensional box shaped element optimised for three viewpoints,

FIG. 8 illustrates the print carrier shown in FIG. 7 as it is interpreted from the first viewpoint,

FIG. 9 illustrates the print carrier shown in FIG. 7 as it is interpreted from the second viewpoint and

FIG. 10 illustrates the print carrier shown in FIG. 7 as it is interpreted from the third viewpoint.

### DESCRIPTION OF PREFERRED EMBODIMENTS

In the following specific embodiments of the invention will be described. In FIG. 1 a print carrier illustrating a three-dimensional box shaped element optimised for two viewpoints is illustrated. The two viewpoints are shown at 101 and 103. The distance between the viewpoints 101,103 and the print carrier 104 has been truncated for illustration purpose as shown by the dotted lines. A first part 105 of the print carrier 104 is a perspective projection of a first side of the three-dimensional box shaped element that is to be illustrated by the print carrier. This side has been transformed according to the line of sight defined by the viewpoint 101. A second part 107 of the print carrier 104 is a perspective projection of a second side of the three-dimensional box shaped element that is to be illustrated by the print carrier. This side has been transformed according to the line of sight defined by the viewpoint 103. The two sides are transformed in accordance with a common point, which is a point on the line 109 connecting the parts 105, 107. The third part 111, being a third side of the three-dimensional element, is defined as the area delimited by the lines 113 and 115. The line 113 is between the first viewpoint 101 and a point 117 on the second part 107 and the line 115 is between the second viewpoint 103 and a point 119 on the first part 105. In an embodiment the points 117 and 119 have been chosen as the points on the third part being farthest away from respectively the first viewpoint 101 and the second viewpoint 103.

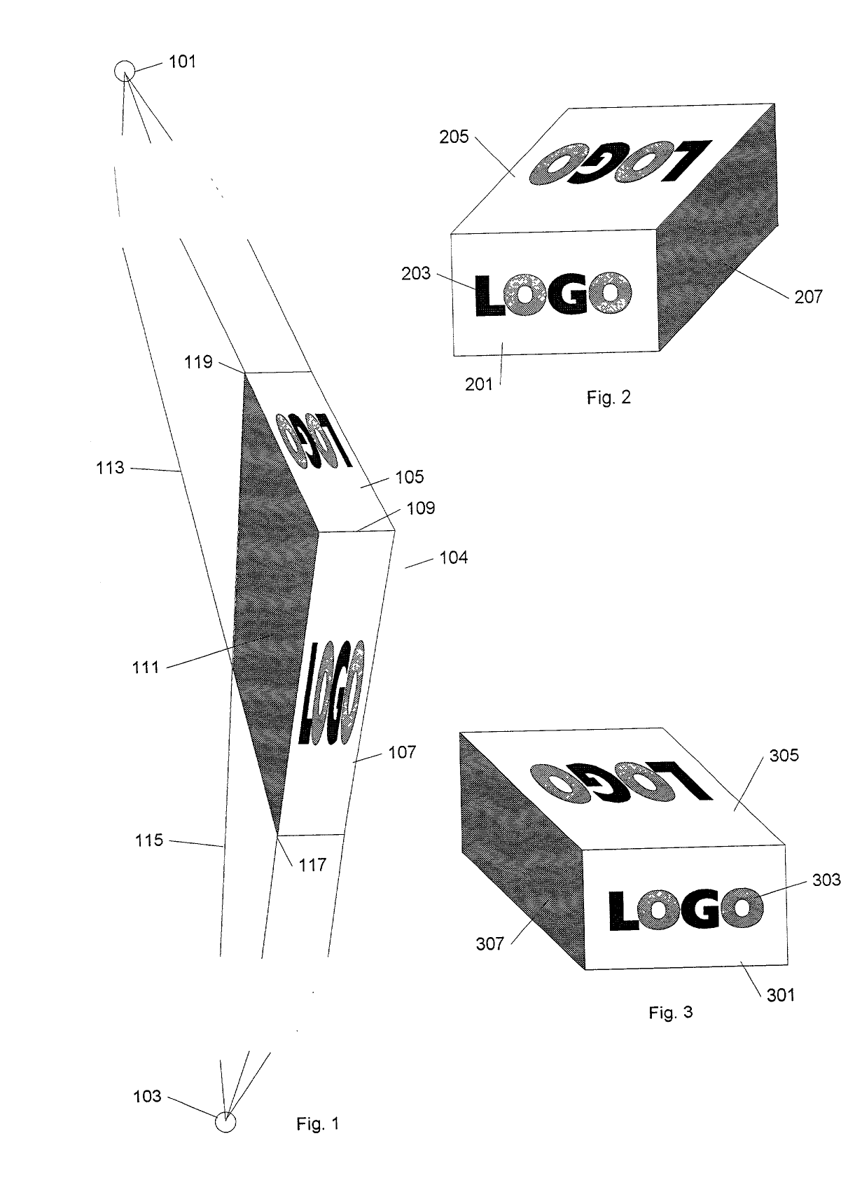

FIG. 2 illustrates the print carrier shown in FIG. 1 as it is intercepted from the first viewpoint. Because of the transformation explained above, the plane print carrier is intercepted as a box shaped element. The side 201 is optimised for this first viewpoint as well as the logo 203 on this side is optimised for the first viewpoint. It is also to be noticed that even though the other visible sides 205 and 207 have not been specifically optimised for the first viewpoint, they are still used for interpreting the image illustrated on the print carrier as a box shaped three-dimensional element.

FIG. 3 illustrates the print carrier shown in FIG. 1 as it is interpreted from the second viewpoint. Again, because of the transformation explained above, the plane print carrier is interpreted as a box shaped element. The side 301 is optimised for this second viewpoint as well as the logo 303 on this side is optimised for the second viewpoint. It is also to be noticed that even though the other visible sides 305 and 307 have not been specifically optimised for the second viewpoint, they are still used for interpreting the image illustrated on the print carrier as a box shaped three-dimensional element.

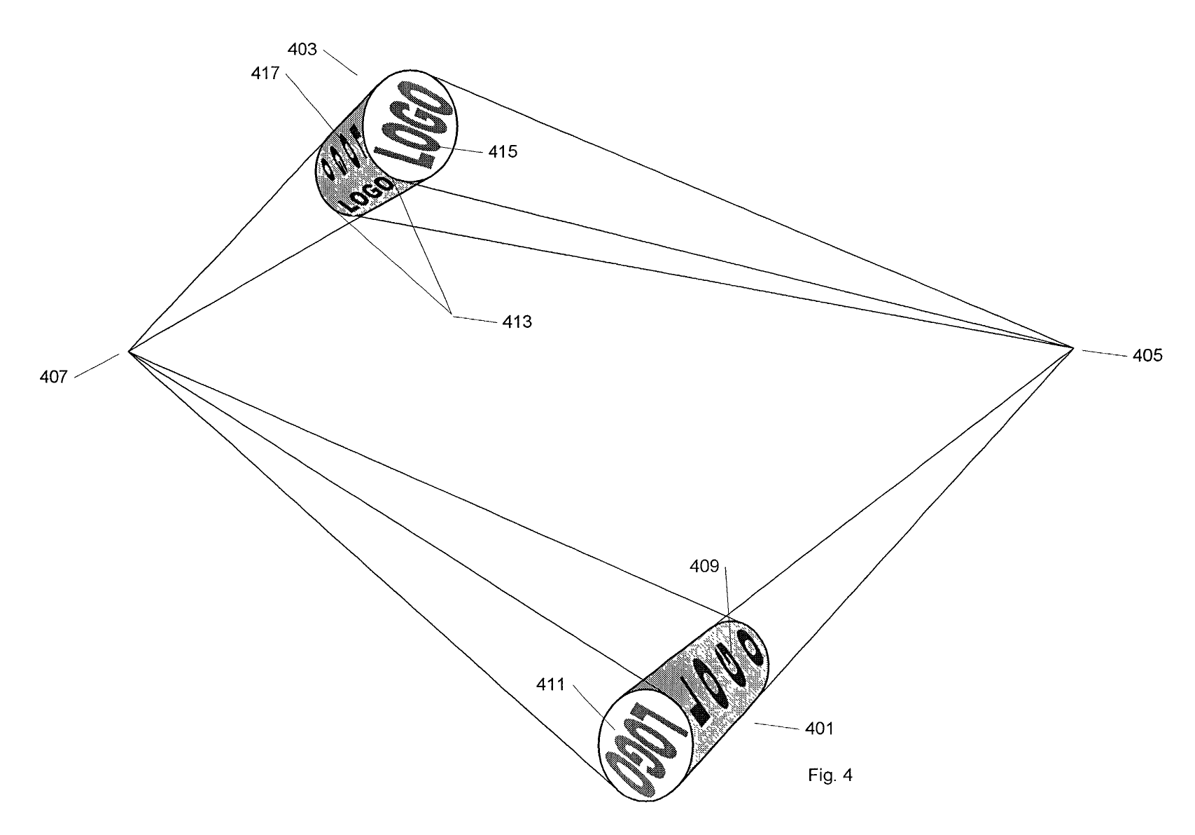

FIG. 4 shows two plane print carriers each illustrating a three-dimensional cylinder shaped element—one 401 optimised for two viewpoints and the other 403 optimised for three viewpoints. The two viewpoints for which the cylinder 401 has been optimised are shown at 405 and 407. A first part 409 of the print carrier 401 is a perspective projection of a first side of the three-dimensional cylinder shaped element that is to be illustrated by the print carrier. This side has been transformed according to the line of sight defined by the viewpoint 405. A second part 411 of the print carrier 401 is a perspective projection of a second side of the three-dimensional cylinder shaped element that is to be illustrated by the print carrier 401. This side has been transformed according to the line of sight defined by the viewpoint 407.

The print carrier 403 has been optimised for three viewpoints 405, 407 and 413. A first part 415 of the print carrier 403 is a perspective projection of a first side of the three-dimensional cylinder shaped element that is to be illustrated by the print carrier. This side has been transformed according to the line of sight defined by the viewpoint 405. A second part 417 of the print carrier 403 is a perspective projection of a second side of the three-dimensional box shaped element that is to be illustrated by the print carrier 403. This side has been transformed according to the line of sight defined by the viewpoint 407. A third part or at least the logo at this third part 419 is a perspective projection of a third side of the three-dimensional cylinder shaped element or at least the logo that is to be illustrated by the print carrier 403.

FIG. 5 illustrates the print carrier shown in FIG. 4 as it is interpreted from an optimal viewpoint. The print carrier comprises a first part 501 with a logo optimised for a first viewpoint 502, a second part 503 with a logo optimised for a second viewpoint 504 and a third part 505 with a logo optimised for a third viewpoint 506. The combination of the three parts gives the impression of a three-dimensional cylinder shaped element when seen from all three viewpoints 502, 504 and 506.

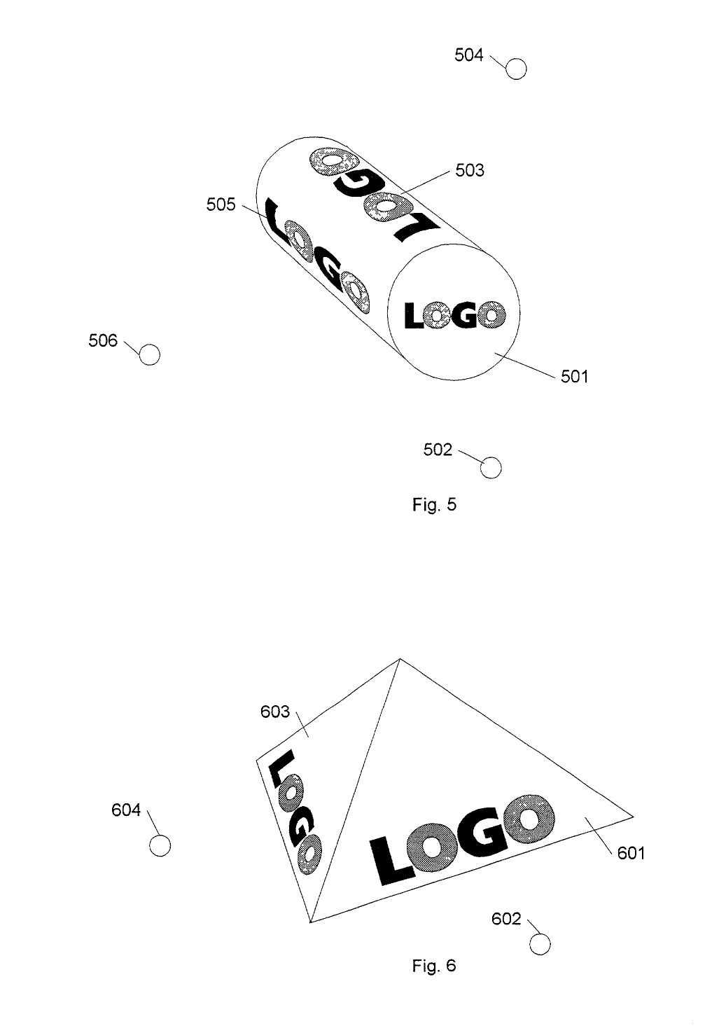

FIG. 6 shows a print carrier illustrating a three-dimensional pyramid shaped element optimised for two viewpoints. The print carrier comprises a first part 601 with a logo optimised for a first viewpoint 602, a second part 603 with a logo optimised for a second viewpoint 604. The combination of the two parts gives the impression of a three-dimensional cylinder shaped element when seen from both viewpoints 602 and 604.

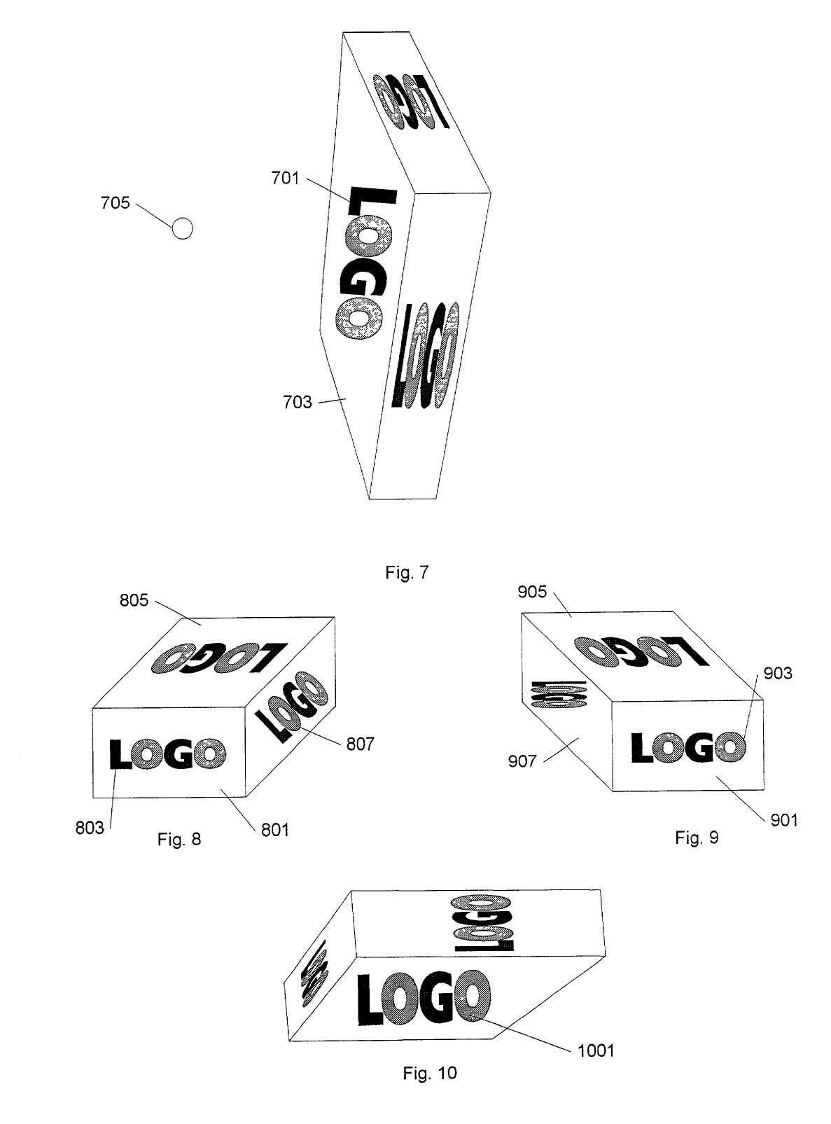

FIG. 7 is a print carrier illustrating a three-dimensional box shaped element optimised for three viewpoints. In this example the print carrier illustrates the three-dimensional box shaped element explained in FIG. 1. A Logo 701 has been added to the third part 703 and the logo is a perspective projection from the third viewpoint 705.

FIG. 8 illustrates the print carrier shown in FIG. 7 as it is intercepted from the first viewpoint. Because of the transformation explained above, the plane print carrier is intercepted as a box shaped element. The side 801 is optimised for this first viewpoint as well as the logo 803 on this side is optimised for the first viewpoint. It is also to be noticed that even though the other visible sides 805 and 807 have not been specifically optimised for the first viewpoint, they are still used for intercepting the image illustrated on the print carrier as a box shaped three-dimensional element.

FIG. 9 illustrates the print carrier shown in FIG. 7 as it is intercepted from the second viewpoint. Again, because of the transformation explained above, the plane print carrier is intercepted as a box shaped element. The side 901 is optimised for this second viewpoint as well as the logo 903 on this side is optimised for the second viewpoint. It is also to be noticed that even though the other visible sides 905 and 907 have not been specifically optimised for the second viewpoint, they are still used for intercepting the image illustrated on the print carrier as a box shaped three-dimensional element.

FIG. 10 illustrates the print carrier shown in FIG. 7 as it is intercepted from the third viewpoint. In this case the logo 1001 can be intercepted from the third viewpoint.

The advertisement print may be viewed directly or via a camera broadcasting the print, e.g. when the print is placed on a sport arena.

1. An advertisement print being printed on a substantially plane print carrier, said print being a transformation of a three-dimensional element having a number of visible sides defined by at least a first viewpoint and a second viewpoint, where said print comprises a first part being a perspective projection of a first of said predefined visible sides to said print carrier according to a first line of sight defined by said first viewpoint and a second part being a perspective projection of a second of said visible sides to said print carrier according to said second line of sight defined by said second viewpoint.

2. An advertisement print according to claim 1, wherein the advertisement print further comprises a third part illustrating a perspective projection of a third of said visible sides to said print carrier according to a combination of a third line of sight at least defined by said first viewpoint and a point on said second part and a fourth line of sight at least defined by said second viewpoint and a point on said first part.

3. An advertisement print according to claim 2, wherein the third part is bounded by said first and second part and a first line being parallel to a third line of sight defined by said first viewpoint and a point being common for said second part and said third part having the longest distance to said first viewpoint and a second line being parallel to a fourth line of sight defined by said second viewpoint and a point being common for said first part and said third part having the longest distance to said second viewpoint,

4. An advertisement print according to any of the claims 1-3, wherein at least said first and second side on said three-dimensional element comprise commercial information.

5. An advertisement print according to any of the claims 1-4, wherein at least a fourth part is placed on said third part, said fourth part being a perspective projection of an object to said print carrier according to a fifth line of sight defined by a third viewpoint.

6. An advertisement print according to any of the claims 1-5, wherein said three-dimensional element is a box and said first visible side is a first surface on said box, said second visible side is a second surface on said box and said third visible side is a third surface on said box being visible from both said first viewpoint and said second viewpoint.

7. An advertisement print according to any of the claims 1-5, wherein said three-dimensional element is a cylinder and said first visible side is a first surface on said cylinder, said second visible side is a second surface on said cylinder and said third visible side is a third surface on said cylinder being visible from both said first viewpoint and said second viewpoint.

8. An advertisement print according to any of the claims 1-7, wherein said first line of sight is pointing in a direction substantially towards said second viewpoint and said second line of sight is pointing in a direction substantially towards said first viewpoint.

9. An advertisement print according to any of the claims 1-8, wherein said print carrier is a removable mat.

10. An advertisement print according to any of the claims 1-8, wherein said print carrier is a ground surface such as a lawn, a slope along a road, a yard, or a parking lot.

11. An advertisement print according to claim 10, wherein said ground surface is the ground surface of a cricket field.

12. An advertisement print according to any of the claims 1-8, wherein said image is provided by a projector pointing towards a substantially plane surface.
